(19) United States
(12) Patent Application Publication
(10) Pub. No.: US 2026/0340320 A1
(43) Pub. Date: Oct. 29, 2026

(54) METHODS AND SYSTEMS FOR TRAINING LARGE LANGUAGE MODELS FOR TRANSLATING TAGGED STRINGS FROM A SOURCE LANGUAGE TO A DESTINATION LANGUAGE

(71) Applicant: Y.E. Hub Armenia LLC, Yerevan (AM)

(72) Inventors: Denis ELSHIN, Moscow (RU); Georgii IVANOV, Moscow (RU)

(21) Appl. No.: 19/541,067

(22) Filed: Feb. 16, 2026

(30) Foreign Application Priority Data
Apr. 25, 2025 (RU) 2025110870

(51) Int. Cl. G06F 40/58; G06N 3/0895; G10L 15/26

(52) U.S. Cl. CPC G06F 40/58; G06N 3/0895; G10L 15/26

(57) ABSTRACT

Methods and servers for training Large Language Models (LLMs) are disclosed. The server may generate, using at least one Neural Network (NN), a Format Neutral Placeholder (FNP) string triplet based on a string triplet. The server may execute contrastive training of the LLM using the FNP string triplet for translating FNP source strings to FNP destination strings. The server may acquire an inference tagged source string. The server may generate an inference FNP source string by replacing one or more tags from the inference tagged source string by one or more FNPs. The server may generate, using the trained LLM, an inference FNP destination string. The server may generate an inference tagged destination string by replacing one or more FNPs from the inference FNP destination string by one or more tags.

### CROSS-REFERENCE

The present application claims priority to Russian Patent Application No. 2025110870, entitled “Methods and Systems for Training Large Language Models for Translating Tagged Strings From a Source Language to a Destination Language”, filed Apr. 25, 2025, the entirety of which is incorporated herein by reference.

### FIELD

The present technology is generally related to text translation, and more specifically, to methods and systems for training large language models for translating tagged strings from a source language to a destination language.

### BACKGROUND

In recent years, the application of Large Language Models (LLMs) in natural language processing has grown. LLMs have been utilized for a variety of language tasks, including translation of textual strings, summarization, and generation of textual strings. LLMs can also be adapted to handle structured text formats, such as markup languages (e.g., HTML, XML, Markdown, and LaTeX). These formats interleave content with structural annotations (i.e., formatting tags), which dictate the formatting, organization, or intended interpretation of the enclosed data. Processing such text using LLMs poses challenges, as it requires the model to understand both the linguistic content and the syntactic rules of the markup.

Training methodologies have been developed in which LLMs are trained from scratch on datasets containing structured text. The objective is to enable the models to accurately translate structured content into alternative representations while preserving both the semantic meaning and the structural integrity of the original input.

US 2024/311546 discloses methods and systems for prompting large language model to generate formatted output.

### SUMMARY

In the context of the present technology, “formatting tags” refer to character tokens embedded within a text string that conveys structural and/or stylistic information about the content. Commonly used in markup languages such as HTML, for example, formatting tags are used to indicate elements like boldness, italics, and the start and end of paragraphs, thereby altering the way the content is displayed and/or interpreted by a rendering system.

In the context of the present technology, “Format Neutral Placeholders” (FNPs) refer to character tokens that serve as non-structural markers within text. In at least some embodiments, FNPs can comprise brackets, braces, and/or other delimiters, which unlike formatting tags, do not impart any display or semantic formatting. FNPs act as neutral position anchors within text, and can be used for later substitution and/or parsing operations within generated output.

Developers have devised methods and devices for overcoming at least some drawbacks present in prior art solutions. Current translation systems, while demonstrating good accuracy on generic textual data, exhibit limitations when translating structured content such as HTML or other markup-based formats. These systems often struggle with preserving the integrity of formatting tags embedded in the text. As a result, they may inadvertently drop, alter, or misplace these tags during translation, leading to structurally broken or invalid output, such as corrupted HTML documents that cannot be reliably rendered and/or parsed.

Developers of the present technology have devised methods and systems for replacing formatting tags with FNPs within inference data. It should be noted that substituting formatting tags by FNPs may aid the LLM in focusing on the semantic content of the text without being disrupted by structurally meaningful tokens. In one non-limiting implementation of the present technology, instead of directly attempting to translate HTML tags, the system is configured to replace HTML tags with FNPs in the input string for the LLM. For example, “<div>” tag is replaced with “{” FNP, while “</div>” tag is replaced with “}” FNP. After translation, the formatting tags may be re-inserted in lieu of respective FNPs that are found in the translated content. Substitution in the input string and reinsertion in the output string may help the model to better process and preserve structural markers without being disrupted by syntactic complexity of markup languages. In at least some implementations of the present technology, by applying this substitution and reinsertion, the proportion of correctly preserved formatting tags in the translated content increased from 36% to 76%.

Developers of the present technology have devised a Reinforcement Learning (RL) data augmentation strategy to guide the model toward accurately handling structured domains. The RL data augmentation strategy involves alignment techniques and augmentation logic designed to reinforce the model's ability to recognize and preserve FNPs throughout the translation process, as opposed to formatted tags, which can be reinserted following the translation operation.

In at least some embodiments, the RL data augmentation strategy may comprise use of two Neural Networks for generating a modified RL corpus. The first NN may be configured to insert FNPs in the source language to generate modified source strings. The second NN may be configured to insert FNPs in the destination language to generated modified destinations strings. The first NN and the second NN may be employed to generate synthetic data to fine-tune the model using contrastive learning techniques.

Developers have realized that employing the RL data augmentation strategy may allow the LLM to handle diverse structured content types, even in cases involving complex and/or nested structured content. In at least one implementation of the present technology, the RL data augmentations strategy for fine-tuning the LLM may result in an increase of accurate tag preservation rate, reaching 99% in some experimental evaluations.

In some aspects, the techniques described herein relate to a method of training a Large Language Model (LLM) for translating tagged strings from a source language to a destination language, the method executable by a server and including: generating, using at least one Neural Network (NN), a Format Neutral Placeholder (FNP) string triplet based on a string triplet, the string triplet including (i) a source string, (ii) a positive destination string, and (iii) a negative destination string, the FNP string triplet including (i) a FNP source string, (ii) a FNP positive destination string, and (iii) a FNP negative destination string, the generating including: generating, using the at least one NN, the FNP source string by inserting one or more FNPs into the source string, generating, using the at least one NN, the FNP positive destination string by inserting the one or more FNPs into the positive destination string, and generating, using the at least one NN, the FNP negative destination string by inserting the one or more FNPs into the negative destination string; executing contrastive training of the LLM using the FNP string triplet for translating FNP source strings to FNP destination strings; acquiring an inference tagged source string; generating an inference FNP source string by replacing one or more tags from the inference tagged source string by one or more FNPs; generating, using the trained LLM, an inference FNP destination string; and generating an inference tagged destination string by replacing one or more FNPs from the inference FNP destination string by one or more tags.

In some aspects, the techniques described herein relate to a method, wherein the method further includes: generating, using a first augmentation logic and a second augmentation logic, an Augmented FNP (AFNP) string triplet based on the FNP string triplet, the AFNP string triplet including an AFNP source string, an AFNP positive destination string, and an AFNP negative destination string, the generating including: generating, using the first augmentation logic independent from the first augmentation logic, the AFNP source string and the AFNP positive destination string by at least one of: (i) synchronously removing one or more FNPs from both the FNP source string and the FNP positive destination string, and (ii) synchronously inserting one or more additional FNPs to in both the FNP source string and the FNP positive destination string; and wherein the executing contrastive training includes executing contrastive training based on the AFNP string triplet.

In some aspects, the techniques described herein relate to a method, wherein the generating the AFNP string triplet further includes: generating, using the second augmentation logic, the AFNP negative destination string by at least one of: (i) removing one or more FNPs from the FNP negative destination string, (ii) inserting one or more additional FNPs to the FNP negative destination string.

In some aspects, the techniques described herein relate to a method, wherein the inference tagged source string includes a plurality of nested tags, the method further includes: generating a simplified inference tagged source string based on the inference tagged source string by removing one or more tags of a first nested order while keeping the one or more tags of a second nested order; and wherein the generating the inference tagged destination string further includes re-inserting the one or more tags of the first nested order.

In some aspects, the techniques described herein relate to a method, wherein the at least one NN is a single NN, the generating the FNP string triplet including: concatenating the source string and the destination string, thereby generating a concatenated source-destination string; and generating, using the single NN, a FNP concatenated source-destination string, the FNP concatenated source-destination string by inserting the one or more FNPs into the concatenated source-destination string.

In some aspects, the techniques described herein relate to a method, wherein the at least one NN includes a first NN and a second NN, the generating the FNP string triplet including: providing the source string to the first NN, the first NN being configured to generate the FNP source string by inserting the one or more FNPs into the source string; providing the FNP source string and the positive destination string to the second NN, the second NN being configured to generate the FNP positive destination string by inserting the one or more FNPs into the positive destination string; and providing the FNP source string and the negative destination string to the second NN, the second NN being configured to generate the FNP negative destination string by inserting the one or more FNPs into the negative destination string.

In some aspects, the techniques described herein relate to a method, wherein the first NN is configured to operate in a sampling mode and the second NN is configured to operate in a greedy mode.

In some aspects, the techniques described herein relate to a method, wherein the one or more tags are mark-up tags from a mark-up language.

In some aspects, the techniques described herein relate to a method, wherein the mark-up language is HTML.

In some aspects, the techniques described herein relate to a method, wherein the acquiring the inference tagged source string includes: generating an inference source string based on audio data, the inference source string having a first portion indicative of a given speaker and a second portion indicative of uttered content by the given speaker; and generating a given FNP source string by inserting one or more FNPs of a first type about the first portion of the inference source string, and one or more FNPs of a second type about the second portion of the inference source string.

In some aspects, the techniques described herein relate to a server for training a Large Language Model (LLM) for translating tagged strings from a source language to a destination language, the server being configured to: generate, using at least one Neural Network (NN), a Format Neutral Placeholder (FNP) string triplet based on a string triplet, the string triplet including (i) a source string, (ii) a positive destination string, and (iii) a negative destination string, the FNP string triplet including (i) a FNP source string, (ii) a FNP positive destination string, and (iii) a FNP negative destination string, to generate includes the server configured to: generate, using the at least one NN, the FNP source string by inserting one or more FNPs into the source string, generate, using the at least one NN, the FNP positive destination string by inserting the one or more FNPs into the positive destination string, and generate, using the at least one NN, the FNP negative destination string by inserting the one or more FNPs into the negative destination string; execute contrastive training of the LLM using the FNP string triplet for translating FNP source strings to FNP destination strings; acquire an inference tagged source string; generate an inference FNP source string by replacing one or more tags from the inference tagged source string by one or more FNPs; generate, using the trained LLM, an inference FNP destination string; and generate an inference tagged destination string by replacing one or more FNPs from the inference FNP destination string by one or more tags.

In some aspects, the techniques described herein relate to a server, wherein the server is further configured to: generate, using a first augmentation logic and a second augmentation logic, an Augmented FNP (AFNP) string triplet based on the FNP string triplet, the AFNP string triplet including an AFNP source string, an AFNP positive destination string, and an AFNP negative destination string, to generate includes the server configured to: generate, using the first augmentation logic independent from the first augmentation logic, the AFNP source string and the AFNP positive destination string by at least one of: (i) synchronously removing one or more FNPs from both the FNP source string and the FNP positive destination string, and (ii) synchronously inserting one or more additional FNPs to in both the FNP source string and the FNP positive destination string; and and wherein to execute contrastive training includes the server configured to execute contrastive training based on the AFNP string triplet.

In some aspects, the techniques described herein relate to a server, wherein to generate the AFNP string triplet further includes the server configured to: generate, using the second augmentation logic, the AFNP negative destination string by at least one of: (i) removing one or more FNPs from the FNP negative destination string, (ii) inserting one or more additional FNPs to the FNP negative destination string.

In some aspects, the techniques described herein relate to a server, wherein the inference tagged source string includes a plurality of nested tags, the server being further configured to: generate a simplified inference tagged source string based on the inference tagged source string by removing one or more tags of a first nested order while keeping the one or more tags of a second nested order; and wherein to generate the inference tagged destination string further includes the server configured to re-insert the one or more tags of the first nested order.

In some aspects, the techniques described herein relate to a server, wherein the at least one NN is a single NN, to generate the FNP string triplet includes the server being configured to: concatenate the source string and the destination string, thereby generating a concatenated source-destination string; and generate, using the single NN, a FNP concatenated source-destination string, the FNP concatenated source-destination string by inserting the one or more FNPs into the concatenated source-destination string.

In some aspects, the techniques described herein relate to a server, wherein the at least one NN includes a first NN and a second NN, to generate the FNP string triplet includes the server being configured to: provide the source string to the first NN, the first NN being configured to generate the FNP source string by inserting the one or more FNPs into the source string; provide the FNP source string and the positive destination string to the second NN, the second NN being configured to generate the FNP positive destination string by inserting the one or more FNPs into the positive destination string; and provide the FNP source string and the negative destination string to the second NN, the second NN being configured to generate the FNP negative destination string by inserting the one or more FNPs into the negative destination string.

In some aspects, the techniques described herein relate to a server, wherein the first NN is configured to operate in a sampling mode and the second NN is configured to operate in a greedy mode.

In some aspects, the techniques described herein relate to a server, wherein the one or more tags are mark-up tags from a mark-up language.

In some aspects, the techniques described herein relate to a server, wherein the mark-up language is HTML.

In some aspects, the techniques described herein relate to a server, wherein to acquire the inference tagged source string includes the server configured to: generate an inference source string based on audio data, the inference source string having a first portion indicative of a given speaker and a second portion indicative of uttered content by the given speaker; and generate a given FNP source string by inserting one or more FNPs of a first type about the first portion of the inference source string, and one or more FNPs of a second type about the second portion of the inference source string.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 is a schematic representation of a networked environment comprising the computing device of FIG. 1, in accordance with at least some non-limiting embodiments of the present technology.

FIG. 3 is a schematic representation of a Supervised Fine-Tuning (SFT) phase of a LLM executable by the computing device, in accordance with at least some non-limiting embodiments of the present technology

FIG. 4 is a schematic representation of a Reinforcement Learning (RL) phase of the LLM executable by the computing device, in accordance with at least some non-limiting embodiments of the present technology.

FIG. 5 is a schematic representation of an inference phase of the LLM executable by the computing device, in accordance with at least some non-limiting embodiments of the present technology.

FIG. 6 is a scheme-block illustration of a method executed by the processor of the computing device of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the present specification, a “server” is hardware capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), textual string (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, “machine learning” refers to a subset of AI techniques where algorithms enable systems to automatically learn from data and improve their performance over time without being explicitly programmed. Machine learning models learn patterns and relationships within the data and apply these learned insights to make predictions and/or decisions in various tasks such as, but not limiting to: natural language processing, natural language generation, image recognition, and searching.

In the context of the present specification, the term “Natural Language Processing” (NLP) refers to a subfield of artificial intelligence (AI) relating to interaction between computers and human language. NLP technologies enable computer systems to analyze, interpret, and generate human, Natural Language (NL), in a manner that is both semantically meaningful and contextually appropriate.

In the context of the present specification, a “Generative Pre-trained Transformer” (GPT) model refers to a neural network model having a transformer-based architecture a trained on extensive and diverse data. The GPT model is designed to generate human-like text by predicting a next textual token in a sequence based on contextual information acquired via one or more attention mechanisms.

In the context of the present specification, a “generative model” refers to an AI model that is configured to generate or “create” new data (e.g., text tokens) based on patterns learned from vast amounts of training data. Generative models can generate different types of new data. For example, a given generative model may generate textual data. In another example, an other given generative model may generate image data.

In the context of the present specification, a “Large Language Model” (LLM) refers to a type of machine learning model, sometimes based on transformer architectures, that is trained on vast amounts of text data to perform various NL processing tasks. LLMs are capable of understanding, generating, and manipulating human language by modeling statistical relationships between words, phrases, and contextual patterns across large-scale corpora.

In the context of the present specification, “Supervised Fine-Tuning” (SFT) refers to a machine learning framework in which a pre-trained model (e.g., LLM) is further trained on a labeled dataset to adapt the pre-trained model to a specific application and/or domain. This SFT process utilizes annotated examples to guide the model's output, enabling it to leverage its prior general training (pre-training) for improved accuracy and/or relevance in task-specific scenarios.

In the context of the present specification, “Reinforcement Learning” (RL) refers to a machine learning framework in which a model (e.g., pre-trained and SFT-trained model) learns to make decisions through iterative interaction with an environment. The model receives evaluative feedback in the form of rewards or penalties based on its actions, which it uses to adjust future behavior with the goal of maximizing a cumulative reward signal over time.

In the context of the present technology, “contrastive training” refers to a machine learning approach used to enhance the performance of a LLM by teaching it to distinguish between desirable (high-quality) and undesirable (low-quality) outputs. This method involves presenting the model with pairs of outputs—positive examples that reflect preferred behavior and negative examples that do not—enabling the model to learn distinctions and refine its output generation accordingly.

In the context of the present technology, “Contrastive Preference Optimization” (CPO) is a loss function employed during contrastive training to reinforce the model's preference for high-quality outputs. By quantifying and maximizing the model's ability to favor positive examples over negative ones, CPO guides the optimization process toward generating outputs that align more closely with desired performance criteria.

With these fundamentals in place, we will now consider some non-limiting examples to illustrate various implementations of aspects of the present technology.

### Computer System

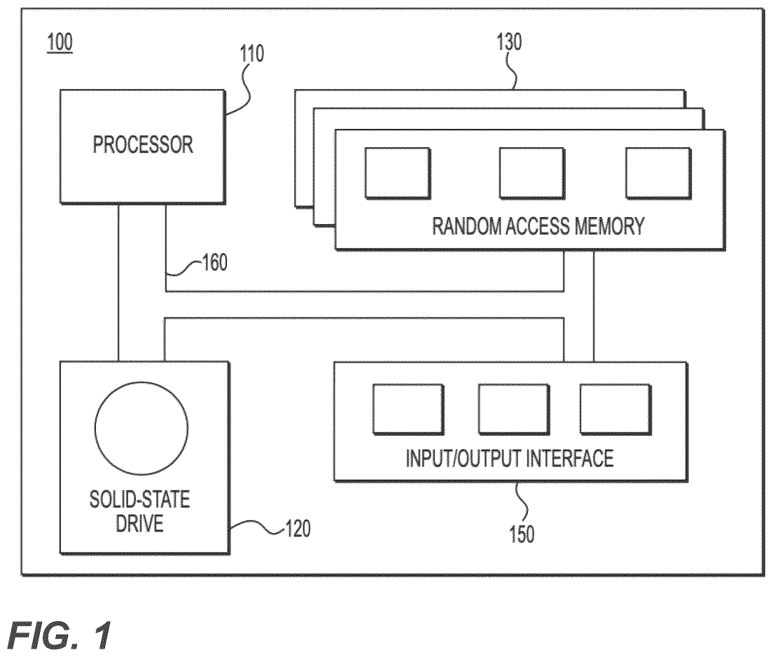

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

### Networked Environment

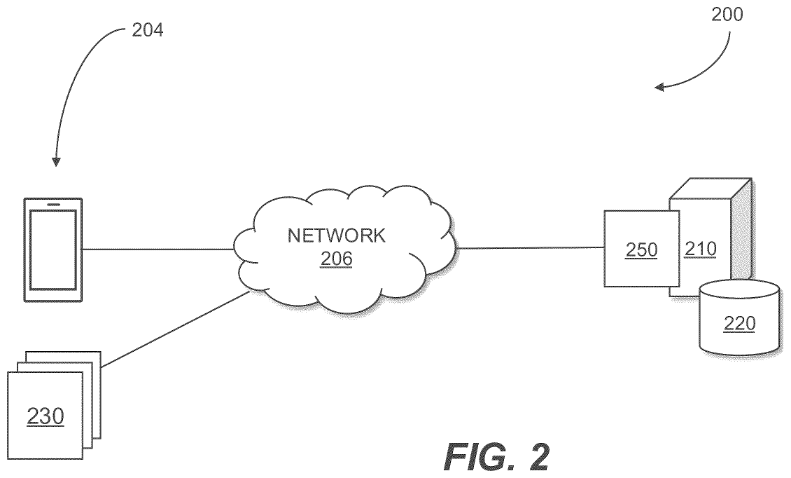

Referring to FIG. 2, there is shown a schematic diagram of a networked environment 200, the networked environment 200 being suitable for implementing non-limiting embodiments of the present technology. It is to be expressly understood that the networked environment 200 as depicted is merely an illustrative implementation of the present technology. Thus, the description thereof that follows is intended to be only a description of illustrative examples of the present technology.

Broadly speaking, the networked environment 200 is configured for providing communication between inter alia a plurality of electronic devices 204, a communication network 206, and a server 210.

As mentioned above, the networked environment 200 comprises an electronic device 204. As such, the electronic device 204, or simply “device” 204 can sometimes be referred to as a “client device”. In the context of the present specification, unless provided expressly otherwise, “electronic device” or “device” is any computer hardware that is capable of running a software appropriate to the relevant task at hand. Thus, some non-limiting examples of the device 204 include personal computers (desktops, laptops, netbooks, etc.), smartphones, tablets and the like. In one embodiment, the device 204 may be implemented similarly to how the computer system 100 is implemented. The device 204 comprises hardware and/or software and/or firmware (or a combination thereof), as is known in the art, to transmit requests to the server 210.

The networked environment 200 comprises the communication network 206. In one non-limiting example, the communication network 206 may be implemented as the Internet. In other non-limiting examples, the communication network 206 may be implemented differently, such as any wide-area communication network, local-area communication network, a private communication network and the like. In fact, how the communication network 206 is implemented is not limiting and will depend on inter alia how other components of the networked environment 200 are implemented.

The purpose of the communication network 206 is to communicatively couple at least some of the components of the networked environment 200 such as the client device 204, the server 210, and the database system 220. For example, this means that the server 210 is accessible via the communication network 206 by the client device 204. The communication network 206 may be used in order to transmit information between the client device 204 and the server 210. The transmitted information may be representative of inter alia NL inputs and NL responses.

The networked environment 200 comprises the server 210 that may be implemented as a conventional computer server. In an example of an embodiment of the present technology, the server 210 may be implemented as a Dell™ PowerEdge™ Server running the Linux™ operating system. Needless to say, the server 210 may be implemented in any other suitable hardware and/or software and/or firmware or a combination thereof. In the depicted non-limiting embodiment of present technology, the server 210 is a single server. In alternative non-limiting embodiments of the present technology, the functionality of the server 210 may be distributed and may be implemented via multiple servers. In one embodiment, the server 210 may be implemented similarly to how the computer system 100 is implemented.

As mentioned above, the plurality of resource servers 230 can be accessed via the communication network 206. The plurality of resource servers 230 may be implemented as conventional computer servers. In a non-limiting example of an embodiment of the present technology, a given one of the plurality of resource servers 230 may be implemented as a Dell™ PowerEdge™ Server running the Microsoft™ Windows Server™ operating system. The given one of the plurality of resource servers 230 may also be implemented in any other suitable hardware and/or software and/or firmware or a combination thereof.

The plurality of resource servers 230 are configured to host (web) resources that can be accessed by the device 204 and/or by the server 210. Which type of resources the plurality of resource servers 230 is hosting is not limiting. However, in some embodiments of the present technology, the resources may comprise digital documents, or simply “documents”, that are representative of web pages.

For example, the plurality of resource servers 230 may host web pages, which means that the plurality of resource servers 230 may store documents representative of web pages and which are accessible by the device 204 and/or by the server 210. A given document may be written in a mark-up language and may comprise inter alia (i) content of a respective web page and (ii) computer-readable instructions for displaying the respective web page (content thereof). In at least some embodiments of the present technology, the resources may comprise HTML documents.

A given one of the plurality of resource servers 230 may be accessed by the device 204 in order to retrieve a given document stored on the given one of the plurality of resource servers 230. For example, a user may enter a web address associated with a given web page in the given browser application of the device 204 and, in response, the device 204 may access a given resource server hosting the given web page in order to retrieve the document representative of the given web page for rendering the content of the web page. A given one of the plurality of resource servers 230 may be accessed by the server 210 in order to retrieve a given document stored on the given one of the plurality of resource servers 230.

The server 210 is configured to execute a platform 250. In some embodiments, the platform 250 is configured to acquire NL inputs from the client device 204 and process the NL input and generate a response. In other embodiments, the platform 250 is configured to acquire an HTML document with content in a source language from the plurality of resource servers 230 and generate a translated version of the HTML document in a destination language. In further embodiments, the platform 250 may be configured to acquire audio data, generate subtitle content in a source language, and generate translated subtitle content in a second language.

The networked environment 200 comprises a database system 220. The database system 220 is configured to support the operation of the platform 250. The database system 220 may be configured to store and manage various types of data required to facilitate processing of data by one or more NNs and/or one or more LLMs executed by the server 210.

### Supervised Fine-Tuning (SFT) Phase

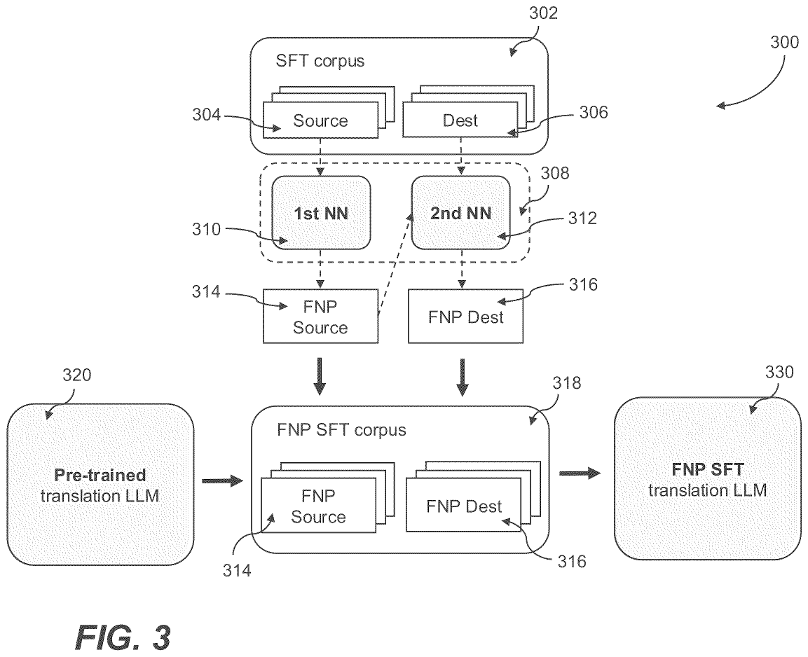

With reference to FIG. 3, there is depicted a SFT training phase 300 of a pre-trained translation LLM 320. It is contemplated that the pre-trained translation LLM 320 is an LLM that has been pre-trained to perform translation from a source language to a destination language. How an LLM is pre-trained for translation tasks is not particularly limiting.

It is contemplated that pre-training an LLM for a translation task may be a multi-phase training process that allows the LLM (e.g., a GPT model) to learn representations of language structures and semantic meanings for performing a given translation task. In some embodiments, pre-training of the LLM may comprise large-scale unsupervised pre-training using vast corpora of monolingual and/or bilingual texts. For multilingual models, aligned texts in more than two languages may be employed, allowing the multilingual model to develop a shared linguistic space where similar concepts across languages are represented closely. It is contemplated that aligned bilingual corpora can also be used during supervised pre-training. Parallel corpora, which comprises sentences in a source language paired with their translations in a destination language can be generated and provided to the LLM for training purposes. The LLM may be pre-trained to generate a target sentence given a source sentence by mapping syntactic and semantic features from one language to another. In some embodiments, pre-training may comprise a domain-specific fine-tuning, where the model is adapted to specific translation domains, styles, and/or languages using smaller, domain-specific, parallel corpora. During domain-specific fine-tuning, the model may learn to handle nuances like idiomatic expressions, domain-specific terminology, and/or stylistic preferences.

In some embodiments of the present technology, the server 210 may be configured to acquire an SFT corpus 302 comprising pairs of SFT strings. It is contemplated that the server 210 may be configured to generate a modified SFT corpus 318 and use the modified SFT corpus 318 during the SFT phase of the pre-trained translation LLM 320, instead of using the SFT corpus 302.

In this embodiment, the SFT corpus 302 comprises a pair of parallel strings comprising a source string 304 in a source language and a parallel destination string 306 in a destination language. The server 210 is configured to employ at least one NN to generate an FNP source string 314 and an FNP destination string 316.

In one embodiment, the server 210 may be configured to employ a first NN 310 to generate the FNP source string 314 based on the source string 304. The server 210 may also employ a second NN 312 generate an FNP destination string 316 based on the FNP source string 314 and the destination string 306. In one example, if the source string 304 is “I saw a cat”, the first NN 310 may be configured to generate the FNP source string 314 “I (saw) a cat”, which comprises inserted FNPs “(” and “)” before and after the word “saw”, respectively. In this example, the second NN 320 may be configured to acquire the FNP source string 314 “I (saw) a cat and the destination string 306 is “ [symbol] [symbol] [symbol] ”, and in response, generate the FNP destination string 316 “ [symbol] ( [symbol] ) [symbol] ”, which comprises inserted FNPs “(” and “)” before and after the word “ [symbol] ”, respectively.

In some embodiments, the first NN 310 may be a sequence-to-sequence model operated by the server 210 in a sampling mode for generating the FNP source string 314. Broadly, a sequence-to-sequence may comprise an encoder and a decoder. The encoder processes an input sequence to generate a context representation, which is then used by the decoder to generate an output sequence. The decoder can operate in a “sampling mode”, wherein, during inference, each token in the output sequence is selected probabilistically from the model's predicted distribution rather than deterministically selecting the most probable token. The sampling mode allows for stochastic generation of outputs, enabling the model to produce diverse sequences from the same input. This contrasts with greedy decoding or beam search approaches, for example, which prioritize the most likely outputs. Sampling may incorporate techniques such as top-k sampling or nucleus (top-p) sampling to inter alia balance diversity and coherence in generated sequences.

In some embodiments, the second NN 312 may be configured to acquire two inputs (the FNP source string 314 and the destination string 306) and generate a single output (the FNP destination string 316). In these embodiments, the second NN 312 may be operated by the server 210 in a greedy mode for generating the FNP destination string 316. Broadly, the second NN 312 may be configured to receive a first input and a second input, and to generate a single output sequence based on both inputs. The second NN 312 comprises a processing architecture that is configured to combine the first and second inputs (e.g., via concatenation, attention mechanisms, and/or other strategies) and uses this integrated representation to condition the generation of the output. In contrast to the first NN 310, the second NN 312 operates with decoding in a “greedy mode” during inference, wherein at each generation step, the output token with the highest probability is selected from the predicted probability distribution. This deterministic approach ensures that the most likely token is chosen at every step, producing a single, high-probability output sequence without exploring alternative generation paths.

In other embodiments, it is contemplated that the server 210 may be configured to use a single NN 308 (instead of the first NN 310 and the second NN 312) in order to generate the FNP source string 314 and the FNP destination string 316. It is contemplated that the single NN 308 may operate in a sampling mode. In these other embodiments, the source string 304 and the destination string 306 may be concatenated into a concatenated string “I saw a cat [symbol] [symbol] [symbol] ”. The single NN may be configured to generate a modified concatenated string “I (saw) a cat [symbol] ( [symbol] ) [symbol] ”. The modified concatenated string may be used to generate the FNP source string 314 and the FNP destination string 316. It is contemplated that the source string and the destination string may be concatenated with a separation token between them in the concatenated string, without departing from the scope of the present technology.

It is contemplated that the server 210 may be configured to generate pairs of FNP source and destination strings for respective pairs of source and destination strings in the SFT corpus 302, similarly to how the server 210 is configured to generate the FNP source string 314 and the FNP destination string 316 for the source string 304 and the destination string 306. The pairs of FNP source and destination strings may for the FNP SFT corpus 318.

In this embodiment, the server 210 is configured to perform SFT on the pre-trained translation LLM 320 based on the FNP SFT corpus 318. As a result, the server 210 is configured to generate of an FNP SFT translation LLM 330. The FNP SFT translation LLM 330 is configured to use a given source string with one or more FNPs at given positions in the given source string (e.g., before and after a given word in the source language) to generate a given destination string with one or more FNPs located at corresponding positions in the destination string (e.g., before and after a corresponding translate word in the destination language).

### Reinforcement Learning (RL) Phase

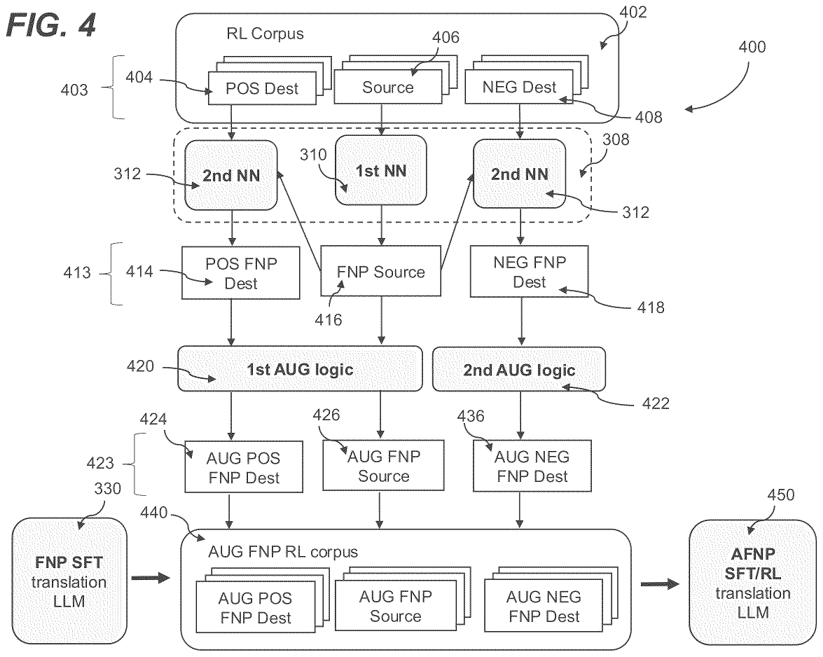

With reference to FIG. 4, there is depicted an RL training phase 400 of the FNP SFT translation LLM 330 generated following the SFT training phase 300. The server 210 is configured to acquire an RL corpus 402 comprising a plurality of string triplets. For example, the RL corpus 402 comprises a string triplet 403 comprising a source string 406, a positive destination string 404, and a negative destination string 408. The server 210 may be configured to generate one or more modified string triplets based on the string triplet 403 for training the FNP SFT translation LLM 330

Broadly speaking, during the RL training, the FNP SFT translation LLM 330 may be configured to optimize a policy and/or representation function based on input data comprising string triplets. Each triplet includes a source string, a positive destination string (representing a semantically or functionally similar counterpart to the source string), and a negative destination string (representing a dissimilar or incorrect counterpart to the source string). The training data may further associate positional information with each string or string segment, indicating the location of substrings within a larger context. The server 210 may execute contrastive learning on the FNP SFT translation LLM 330, wherein the objective is to learn representations or action-value functions that bring the source string and positive destination string closer together in the learned embedding space and/or pushing the source string and negative destination string farther apart. The FNP SFT translation LLM 330 may optimize a contrastive loss function such as, but not limited to: a triplet loss, an InfoNCE loss, and/or other margin-based loss. The RL training process may comprise policy updates guided by reward signals that reflect improvements in representation quality, alignment accuracy, and/or task-specific performance, as measured through a given contrastive learning framework. The FNP SFT translation LLM 330 thereby can learn to distinguish between similar and dissimilar string pairs.

The server 210 is configured to use at least one NN to generate a FNP string triplet 413 based on the string triplet 403. In one embodiment, the at least one NN may be a single NN, such as the single NN 308. In other embodiments, the at least one NN may comprise the first NN 310 and the second NN 312. It is contemplated that the single NN 308 and/or the first NN 310 and the second NN 312 may be used to generate the FNP string triplet 413 similarly to how the single NN 308 and/or the first NN 310 and the second NN 312 are used to generate the FNP string pair including the FNP source string 314 and the FNP destring string 316, without departing from the scope of the present technology.

In one embodiment, the server 210 may be configured to employ the first NN 310 to generate the FNP source string 416 based on the source string 406. Similarly to what has been described above, the first NN 310 may be used to generate an FNP source string 416 based on the source string 406 by inserting one or more FNPs into the source string 406. For example, if the source string 406 is “I saw a cat”, the first NN 310 may be configured to generate an FNP source string 416 “I (saw) a cat”.

In one embodiment, the server 210 may be configured to employ the second NN 312 generate the FNP positive destination string 414 based on the FNP source string 416 and the positive destination string 404. Similarly to what has been described above, the second NN 312 may be used to generate the FNP positive destination string 414 by inserting one or more FNPs into the positive destination string 404. For example, if the FNP source string 416 is “I (saw) a cat” and the positive destination string 404 is “ [symbol] [symbol] [symbol] ”, the second NN 312 may be configured to generate the FNP positive destination string 414 “ [symbol] ( [symbol] ) [symbol] ”.

In one embodiment, the server 210 may be configured to employ the second NN 312 generate the FNP negative destination string 418 based on the FNP source string 416 and the negative destination string 408. Similarly to what has been described above, the second NN 312 may be used to generate the FNP negative destination string 418 by inserting one or more FNPs into the negative destination string 408. For example, if the FNP source string 416 is “I (saw) a cat” and the negative destination string 408 is “ [symbol] [symbol] [symbol] ”, the second NN 312 may be configured to generate the FNP negative destination string 418 “ [symbol] ( [symbol] ) [symbol] ”.

As such, in one embodiment, the FNP string triplet 413 comprises the FNP source string 416 “I (saw) a cat”, the FNP positive destination string 414 “ [symbol] ( [symbol] ) [symbol] ”, and the FNP negative destination string 418 “ [symbol] ( [symbol] ) [symbol] ”. In some embodiments, the FNP string triplet 413 may be used to perform contrastive learning on the FNP SFT translation LLM 330. In other embodiments however, the server 210 may be configured to apply one or more augmentation logics onto the FNP string triplet 413 to generate an Augmented FNP (AFNP) string triplet 423 and train the FNP SFT translation LLM 330 based on the AFNP string triplet 423.

### First Augmentation Logic

In one embodiment, the server 210 is configured to use a first augmentation logic 420 for generating an AFNP source string 424 and an AFNP positive destination string 426 by at least one of: (i) synchronously removing one or more FNPs from both the FNP source string 416 and the FNP positive destination string 414, and (ii) synchronously inserting one or more additional FNPs to in both the FNP source string 416 and the FNP positive destination string 414.

For example, if the FNP source string 416 is “I (saw) a cat”, the FNP positive destination string 414 is “ [symbol] ( [symbol] ) [symbol] ”, the server 210 may be configured to generate the AFNP source string 426 “I (saw) a {cat}” by inserting FNPs “{” and “}” before and after the word “cat” in the FNP source string 416 and the AFNP positive destination string 424 “ [symbol] ( [symbol] ) { [symbol] }” by synchronously inserting FNPs “{” and “}” before and after the word “ [symbol] ” (corresponding word to “cat” in destination language” in the FNP positive destination string 414.

In an other example, assuming that the FNP source string 416 is “{I} (saw) a cat”, the FNP positive destination string 414 is “{ [symbol] } ( [symbol] ) [symbol] ”, the server 210 may be configured to generate the AFNP source string 426 “I (saw) a cat” by removing FNPs “{” and “}” before and after the word “I” in the FNP source string 416 and the AFNP positive destination string 424 “ [symbol] ( [symbol] ) [symbol] ” by synchronously removing FNPs “{” and “}” before and after the word “ [symbol] ” (corresponding word to “I” in destination language) in the FNP positive destination string 414.

It is contemplated that synchronous insertions of one or more FNPs means that any FNP that is inserted into a specific word or phrase in the FNP source string 416 is also inserted into the corresponding word or substring in the FNP positive destination string 414. It is contemplated that synchronous removal of one or more FNPs means that any FNP that is removed from a specific word and/or substring in the FNP source string 416 is also removed from the corresponding word and/or substring in the FNP positive destination string 414. Synchronous insertions and/or removal of FNPs via the first augmentation logic 420 ensures that the AFNP source string 426 and the AFNP positive destination string 424 remain consistent with each other in terms of which FNPs are present and their respective positions.

### Second Augmentation Logic

In one embodiment, the server 210 is configured to use a second augmentation logic 420 for generating an AFNP negative destination string 436 by at least one of: (i) removing one or more FNPs from the FNP negative destination string 418, (ii) inserting one or more additional FNPs to the FNP negative destination string 418.

For example, if the FNP negative destination string 418 is “ [symbol] ( [symbol] ) [symbol] ”, the server 210 may be configured to generate the AFNP negative destrination string 428 “ [symbol] ( [symbol] ) { [symbol] ” by inserting the FNP “{” before the word “ [symbol] ” in the FNP negative destination string 418. In another example, if the FNP negative destination string 418 is “ [symbol] ( [symbol] ) [symbol] ”, the server 210 may be configured to generate the AFNP negative destination string 428 “ [symbol] ( [symbol] ) [symbol] }” by inserting the FNP “}” after the word “ [symbol] ” in the FNP negative destination string 418. In further example, if the FNP negative destination string 418 is “ [symbol] ( [symbol] ) [symbol] ”, the server 210 may be configured to generate the AFNP negative destination string 428 “ [symbol] ] ( [symbol] ) [symbol] }” by inserting the FNP “}” after the word “ [symbol] ” in the FNP negative destination string 418 and inserting the FNP “]” after the word “ [symbol] ” in the FNP negative destination string 418. In an additional example, if the FNP negative destination string 418 is “ [symbol] ( [symbol] ) [symbol] ”, the server 210 may be configured to generate the AFNP negative destination string 428 “ [symbol] ( [symbol] ≥}” by removing the FNP “)” after the word “ [symbol] ” in the FNP negative destination string 418. In yet another example, if the FNP negative destination string 418 is “ [symbol] ( [symbol] ) [symbol] ”, the server 210 may be configured to generate the AFNP negative destination string 428 “ [symbol] ( [symbol] [symbol] }” by removing the FNP “)” after the word “ [symbol] ” in the FNP negative destination string 418 and by inserting the FNP “}” after the word “ [symbol] ” in the FNP negative destination string 418.

Let it be assumed that the FNP string triplet 413 comprises the FNP source string 416 “I (saw) a cat”, the FNP positive destination string 414 “ [symbol] ( [symbol] ) [symbol] ”, and the FNP negative destination string 418 “ [symbol] ( [symbol] ) [symbol] ”. In this scenario, the server 210 may be configured to use the first augmentation logic 420 and the (independent) second augmentation 422 to generate at least one of the following AFNP string triplets.
First example:
   AFNP source string 426: “I (saw) a {cat}”
   AFNP positive destination string 424: “ [symbol] ( [symbol] ) { [symbol] }”
   AFNP negative destination string 428: “ [symbol] ( [symbol] ) { [symbol] ”
Second example:
   AFNP source string 426: “I (saw) a {cat}”
   AFNP positive destination string 424: “ [symbol] ( [symbol] ) { [symbol] }”
   AFNP negative destination string 428: “ [symbol] ( [symbol] ) [symbol] ]”
Third example:
   AFNP source string 426: “{I} (saw) a cat”
   AFNP positive destination string 424: “{ [symbol] } ( [symbol] ) [symbol] ”
   AFNP negative destination string 428: “ [symbol] [symbol] ) [symbol] ”
Fourth example:
   AFNP source string 426: “{I} (saw) a cat”
   AFNP positive destination string 424: “{ [symbol] } ( [symbol] ) [symbol] ”
   AFNP negative destination string 428: “ [symbol] ( [symbol] ) [symbol] }”
Fifth example:
   AFNP source string 426: “{I} (saw) a [cat]”
   AFNP positive destination string 424: “{ [symbol] } ( [symbol] ) [ [symbol] ]”
   AFNP negative destination string 428: “[ [symbol] ( [symbol] [symbol] }”

It is contemplated that although the AFNP source string 426 and AFNP positive destination string 424 are generated synchronously by the first augmentation logic 420, the AFNP negative destination string 428 is generated independently from the AFNP source string 426 and AFNP positive destination. Developers have realized that implementing independent augmentation logics for (i) generating an AFNP source string and an AFNP positive destination string and (ii) generating the AFNP negative destination string, allows maintaining FNP coherence between source and positive destination strings following augmentation while not maintaining FNP coherence between the source and negative destination strings.

It is contemplated that the server 210 may be configured to generate AFNP string triplets for respective string triplets in the RL corpus 402, similarly to how the server 210 is configured to generate the AFNP string triplet 423 for the string triplet 403. The AFNP string triplets may for the AFNP RL corpus 440.

In this embodiment, the server 210 is configured to perform RL on the FNP SFT translation LLM 330 based on the AFNP RL corpus 440. For example, the server 210 may be configured to execute contrastive based on the AFNP string triplet 423 and/or other AFNP string triplets from the AFNP RL corpus 440. As a result, the server 210 is configured to generate of an AFNP SFT/RL translation LLM 450. The AFNP SFT/RL translation LLM 450 is configured to distinguish between positive translation examples with coherent FNPs and negative translation example with non-coherent FNPs.

### Inference

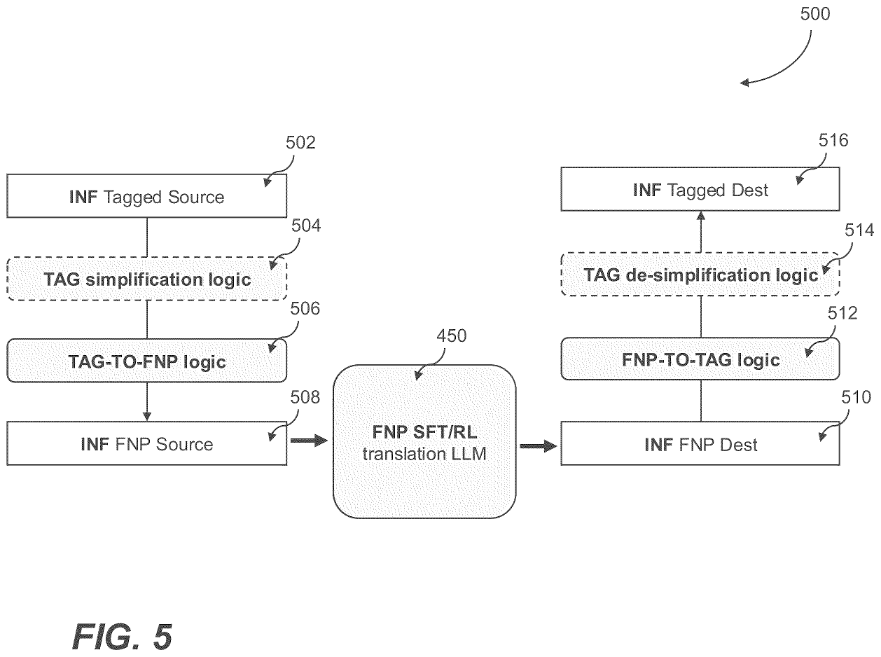

With reference to FIG. 5, there is depicted an inference phase 500 of the LLM 450 in accordance with some non-limiting embodiments of the present technology. The server 210 may be configured to acquire an inference tagged source string 502.

In some embodiments, the server 210 may be configured to execute a tag simplification logic 504 to simplify the tagged source string 502. The tag simplification logic 504 is optional and may be omitted, without departing from the scope of the present technology. The tag simplification logic 504 may be used by the server 210 to simplify strings with nested tags.

In the context of the present technology, “nested formatting tags” refer to the use of tags, such as HTML tags and/or XML tags, for example, arranged in a hierarchical structure where one set of tags is placed within another. This nested arrangement creates a parent-child relationship between the tags and plays a role in how formatting and/or styling are applied to text or content in digital documents.

Let it be assumed that the inference tagged source string 502 is “<i><b>I saw a cat </b></i>”. Here, the “<b>” and “</b>” tags, which indicate bold formatting, are placed inside the “<i>” and “</i>” tags, which indicate italic formatting. This means the bold tags are nested within the italic tags. In this context, the “<b>” and “</b>” tags are considered first-order nested tags, as they are directly enclosed by the other set of tags. Meanwhile, the “<i>” and “</i>” tags are considered second-order nested tags because they encompass the other set of tags and are not enclosed within additional tags in this particular string. In this scenario, the server 210 may be configured to generate a simplified inference tagged source string by removing the second-order nested tags “<i>” and “</i>” from the inference tagged source string 502, resulting in the string “<b>I saw a cat </b>”. It is contemplated that in some embodiments, the server 210 may be configured to remove outer tags, such as paired tags that wrap a text fragment.

In this embodiment, the server 210 may be configured to execute a tag-to-FNP conversion logic 506 in order to generate an inference FNP source string 508. For example, the server 210 may use the tag-to-FNP conversion logic 506 to generate the inference FNP source string 508 “[I saw a cat]”, where tags “<b>” and “</b>” are replaced respective by the FNPs “[” and “]”. It should be noted that an FNP “[“may be a single token, instead of a three tokens for a respective tag “<b>”.

It is contemplated that the tag-to-FNP conversion logic 506 may allow transforming a segment of content (e.g., HTML, XML, etc.) into a representation that facilitates processing and later reconstruction. This transformation begins by parsing an HTML fragment, for example, into a structured format known as the document representation. In this form, the document is broken down into a sequential series of elements, where each element is either a piece of text or an HTML tag. These elements are represented programmatically as pairs, each consisting of a “type” (either “text” or “tag”) and a “value” (the actual content of the text or the name of the tag). The algorithm focuses on converting this structured sequence into two outputs: a simplified text version where HTML tags are replaced by FNPs (e.g., brackets), and a mapping of these FNPs back to the original tags for potential reverse transformation. To manage this, the algorithm utilizes a predefined set of opening FNPs, such as “(”, “[”, “{”, and “<”, for example, which correspond to different levels of tag nesting. During processing, when an opening tag is encountered, it is replaced with an opening FNPs that corresponds to the current nesting level. The nesting level is then incremented, and the association between the FNP and the tag is recorded. Conversely, when a closing tag is identified, the nesting level is decremented, and a closing FNP appropriate to that level is added in the output. Self-closing tags can be handled by inserting both an opening and a closing FNP and recording the corresponding FNP-tag pairs. Textual content is added directly to the output. If any FNPs appear within the text itself, they are treated specially by inserting entries into the FNP-tag mapping with an empty tag, ensuring that these textual brackets are not confused with tag-replacing FNPs. After the entire HTML sequence has been processed, the algorithm generate final results such as the modified output text devoid of HTML tags and comprising FNPs, and a sequence of FNP-tag pairs that allows the original HTML structure to be reconstructed if needed.

In this embodiment, the server 210 may be configured to use the LLM 450 to generate an inference FNP destination string 510. In one non-limiting example, the server 210 may be configured use the LLM 450 to generate the inference FNP destination string 510 “[ [symbol] [symbol] [symbol] ]” based on the inference FNP source string 508 “[I saw a cat]”.

In this embodiment, the server 210 may be configured to execute a FNP-to-tag conversion logic 512 in order to generate an inference tagged destination string 516. For example, the server 210 may use the FNP-to-tag conversion logic 506 to generate the inference tagged destination string 516 “<b> [symbol] [symbol] [symbol] </b>”, where FNPs “[” and “]” are converted respectively to tags “<b>” and “</b>”.

It is contemplated that the FNP-to-tag conversion logic 512 may allow for reconstructing HTML content from a FNP-based representation, using a mapping of FNP-tag pairs generated by the tag-to-FNP conversion logic 508. The FNP-to-tag conversion logic 512 serves as the reverse operation to the tag-to-FNP conversion logic 508, allowing the system to recover structured HTML (for example) from an FNP format. The process begins by iterating character by character through the input that contains various FNPs. As each character is examined, the algorithm determines whether it is a FNP or a text character. When a FNP is encountered, it is checked against the expected FNP in the sequence of reverse mapping pairs. If the FNP does not match the expected one from the reverse mapping list, the algorithm halts and returns an error, signaling that the input sequence is either malformed or has been altered. If the FNP does match, the corresponding tag from the mapping is inserted into the output. The tag may be an opening or closing HTML tag (for example), or an empty string particularly in cases where the original text included FNPs (e.g., brackets) that were not associated with HTML tags and are part of the content itself. For any character that is not a FNP, the algorithm adds it to the output while applying HTML escaping. This step may allow special characters in the text (e.g., “&”) to be represented in HTML form to prevent them from being misinterpreted as code.

It is contemplated that in those embodiments where the tag simplification logic 504 is used, the server 210 may also use a tag de-simplification logic 514 in order to re-insert tags of the second-order nested tags “<i>” and “</i>”. As a result, in these embodiments, the server 210 may be configured to generate the inference tagged destination string 516 “<i><b> [symbol] [symbol] [symbol] </b></i>”.

It should be noted that tag simplification and de-simplification logics are a pair of processes designed to increase reconstruction accuracy of a marked-up sequence of tags. The simplification phase can reduce structural redundancy by collapsing a group of adjacent tags (often separated by whitespace) into a single representative tag. This condensed representation is beneficial for certain processing where the full tag complexity may not be necessary. During simplification, the algorithm tracks the context of the removed tags for potential reversal. Specifically, for each tag that remains after simplification, it records a “prefix” and a “suffix”—the tags that were originally to the left and right of it and which are removed during simplification. This contextual information is stored as a list of triplets, with each triplet containing the tag that was kept, the left-side tags that were removed (prefix), and the right-side tags that were removed (suffix). The de-simplification process uses this recorded data to reconstruct the original sequence of tags. It takes as input the simplified sequence of text with tags and the list of recorded triplets. The algorithm then iterates through the tag sequence. When a tag is encountered, it checks if it matches the tag in the next triplet from the list. If there is a mismatch—that is, if the current tag doesn't match the expected tag in the triplet—the algorithm exits with an error, indicating a potential issue with the integrity of the simplified input or the triplet list. If the tag matches, the algorithm restores the original context by inserting the prefix, the tag itself, and the suffix into the output in that order. Textual elements that are not tags are transferred directly to the output without modification, preserving their original content.

In at least some embodiments of the present technology, the server 210 may be configured to generate an inference source string based on audio data, such as a subtitle string. In these embodiments, the inference source string may have a first portion indicative of a given speaker and a second portion indicative of uttered content by the given speaker. For example, the inference source string may be “Man speaking I saw a cat” wherein “Man speaking” is the first portion and “I saw a cat” is the second portion. The server 210 may also be configured to generate a following subtitle string. For example, the following subtitle string may be “Woman speaking Me too”.

In these embodiments, the server 210 may be configured to generate a given FNP source string by inserting one or more FNPs of a first type about the first portion of the inference source string, and one or more FNPs of a second type about the second portion of the inference source string. For example, the server 210 may be configured to generate the given FNP source string “{Man Speaking}[I saw a cat]”. The server may also be configured to generate an other given FNP string “{Woman speaking}[Me too]”. The server 210 may be configured to generate translated versions of these FNP source subtitle strings similarly to what is described above.

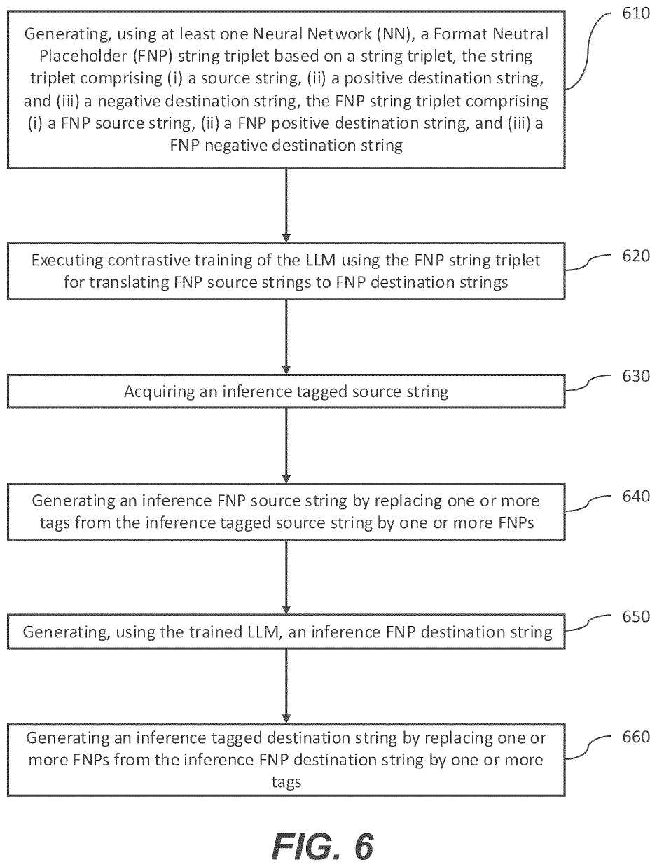

With reference to FIG. 6, there is depicted a flowchart of a method of training a LLM for translating tagged strings from a source language to a destination language. The method may be executed by the server 210. Various steps of the method will now be described.

At step 610, the server 210 is configured to generate, using at least one Neural Network (NN), a FNP string triplet based on a string triplet. In some embodiments, the server 210 may be configured to generate the FNP string triplet 413 based on the string triplet 403. During the step 610, the server 210 may be configured to generate the FNP source string 416 by inserting one or more FNPs into the source string 406. The server 210 may also generate, using the at least one NN, the FNP positive destination string 414 by inserting the one or more FNPs into the positive destination string 404. The server 210 may also generate, using the at least one NN, the FNP negative destination string 418 by inserting the one or more FNPs into the negative destination string 408. In some embodiments, the server 210 may be configured to use the single NN 308 to generate the FNP string triplet 413. In other embodiments, the server 210 may be configured to use the first NN 310 and the second NN 312 to generate the FNP string triplet 413.

At step 620, the server 210 is configured to execute contrastive training of the LLM 330 using the FNP string triplet 413 for translating FNP source strings to FNP destination strings. The server 210 may be configured to generate the LLM 450 by training the 330. In some embodiments, the server 210 may generate, using the first augmentation logic 420 and the second augmentation logic 422, the AFNP string triplet 423 based on the FNP string triplet 413, and executing contrastive training of the LLM 330 based on the AFNP string triplet 423.

At step 630, the server 210 is configured to acquire an inference tagged source string 502. In some embodiments, the server 210 may generate an inference source string based on audio data, and where the inference source string has a first portion indicative of a given speaker and a second portion indicative of uttered content by the given speaker. In these embodiments, the server 210 may generate a given FNP source string by inserting one or more FNPs of a first type about the first portion of the inference source string, and one or more FNPs of a second type about the second portion of the inference source string.

At step 640, the server 210 is configured to generate the inference FNP source string 508 by replacing one or more tags from the inference tagged source string 502 by one or more FNPs. It is contemplated that the server 210 may generate a simplified inference tagged source string based on the inference tagged source string 502 by removing one or more tags of a first nested order while keeping the one or more tags of a second nested order.

At step 650, the server 210 is configured to generate, using the trained LLM 450, the inference FNP destination string 510.

At step 660, the server 210 is configured to generate the inference tagged destination string 516 by replacing one or more FNPs from the inference FNP destination string 510 by one or more tags. The server 210 may employ the FNP-to-tag logic 512 during the step 660.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of training a Large Language Model (LLM) for translating tagged strings from a source language to a destination language, the method executeable by a server and comprising:
generating, using at least one Neural Network (NN), a Format Neutral Placeholder (FNP) string triplet based on a string triplet,
the string triplet comprising (i) a source string, (ii) a positive destination string, and (iii) a negative destination string, the FNP string triplet comprising (i) a FNP source string, (ii) a FNP positive destination string, and (iii) a FNP negative destination string,
the generating comprising:
generating, using the at least one NN, the FNP source string by inserting one or more FNPs into the source string,
generating, using the at least one NN, the FNP positive destination string by inserting the one or more FNPs into the positive destination string, and
generating, using the at least one NN, the FNP negative destination string by inserting the one or more FNPs into the negative destination string;
executing contrastive training of the LLM using the FNP string triplet for translating FNP source strings to FNP destination strings;
acquiring an inference tagged source string;
generating an inference FNP source string by replacing one or more tags from the inference tagged source string by one or more FNPs;
generating, using the trained LLM, an inference FNP destination string; and
generating an inference tagged destination string by replacing one or more FNPs from the inference FNP destination string by one or more tags.

2. The method of claim 1, wherein the method further comprises:
generating, using a first augmentation logic and a second augmentation logic, an Augmented FNP (AFNP) string triplet based on the FNP string triplet, the AFNP string triplet comprising an AFNP source string, an AFNP positive destination string, and an AFNP negative destination string, the generating comprising:
generating, using the first augmentation logic independent from the first augmentation logic, the AFNP source string and the AFNP positive destination string by at least one of: (i) synchronously removing one or more FNPs from both the FNP source string and the FNP positive destination string, and (ii) synchronously inserting one or more additional FNPs to in both the FNP source string and the FNP positive destination string; and
and wherein the executing contrastive training comprises executing contrastive training based on the AFNP string triplet.

3. The method of claim 2, wherein the generating the AFNP string triplet further comprises:
generating, using the second augmentation logic, the AFNP negative destination string by at least one of: (i) removing one or more FNPs from the FNP negative destination string, (ii) inserting one or more additional FNPs to the FNP negative destination string.

4. The method of claim 1, wherein the inference tagged source string comprises a plurality of
nested tags, the method further comprises:
generating a simplified inference tagged source string based on the inference tagged source string by removing one or more tags of a first nested order while keeping the one or more tags of a second nested order;
and wherein the generating the inference tagged destination string further comprises re-inserting the one or more tags of the first nested order.

5. The method of claim 1, wherein the at least one NN is a single NN, the generating the FNP string triplet comprising:
concatenating the source string and the destination string, thereby generating a concatenated source-destination string; and
generating, using the single NN, a FNP concatenated source-destination string, the FNP concatenated source-destination string by inserting the one or more FNPs into the concatenated source-destination string.

6. The method of claim 1, wherein the at least one NN comprises a first NN and a second NN, the generating the FNP string triplet comprising:
providing the source string to the first NN, the first NN being configured to generate the FNP source string by inserting the one or more FNPs into the source string;
providing the FNP source string and the positive destination string to the second NN, the second NN being configured to generate the FNP positive destination string by inserting the one or more FNPs into the positive destination string; and
providing the FNP source string and the negative destination string to the second NN, the second NN being configured to generate the FNP negative destination string by inserting the one or more FNPs into the negative destination string.

7. The method of claim 6, wherein the first NN is configured to operate in a sampling mode and the second NN is configured to operate in a greedy mode.

8. The method of claim 1, wherein the one or more tags are mark-up tags from a mark-up language.

9. The method of claim 8, wherein the mark-up language is HTML.

10. The method of claim 1, wherein the acquiring the inference tagged source string comprises:
generating an inference source string based on audio data, the inference source string having a first portion indicative of a given speaker and a second portion indicative of uttered content by the given speaker; and
generating a given FNP source string by inserting one or more FNPs of a first type about the first portion of the inference source string, and one or more FNPs of a second type about the second portion of the inference source string.

11. A server for training a Large Language Model (LLM) for translating tagged strings from a source language to a destination language, the server being configured to:
generate, using at least one Neural Network (NN), a Format Neutral Placeholder (FNP) string triplet based on a string triplet,
the string triplet comprising (i) a source string, (ii) a positive destination string, and (iii) a negative destination string, the FNP string triplet comprising (i) a FNP source string, (ii) a FNP positive destination string, and (iii) a FNP negative destination string,
to generate comprises the server configured to:
generate, using the at least one NN, the FNP source string by inserting one or more FNPs into the source string,
generate, using the at least one NN, the FNP positive destination string by inserting the one or more FNPs into the positive destination string, and
generate, using the at least one NN, the FNP negative destination string by inserting the one or more FNPs into the negative destination string;
execute contrastive training of the LLM using the FNP string triplet for translating FNP source strings to FNP destination strings;
acquire an inference tagged source string;
generate an inference FNP source string by replacing one or more tags from the inference tagged source string by one or more FNPs;
generate, using the trained LLM, an inference FNP destination string; and
generate an inference tagged destination string by replacing one or more FNPs from the inference FNP destination string by one or more tags.

12. The server of claim 11, wherein the server is further configured to:
generate, using a first augmentation logic and a second augmentation logic, an Augmented FNP (AFNP) string triplet based on the FNP string triplet, the AFNP string triplet comprising an AFNP source string, an AFNP positive destination string, and an AFNP negative destination string, to generate comprises the server configured to:
generate, using the first augmentation logic independent from the first augmentation logic, the AFNP source string and the AFNP positive destination string by at least one of: (i) synchronously removing one or more FNPs from both the FNP source string and the FNP positive destination string, and (ii) synchronously inserting one or more additional FNPs to in both the FNP source string and the FNP positive destination string; and
and wherein to execute contrastive training comprises the server configured to execute contrastive training based on the AFNP string triplet.

13. The server of claim 12, wherein to generate the AFNP string triplet further comprises the server configured to:
generate, using the second augmentation logic, the AFNP negative destination string by at least one of: (i) removing one or more FNPs from the FNP negative destination string, (ii) inserting one or more additional FNPs to the FNP negative destination string.

14. The server of claim 11, wherein the inference tagged source string comprises a plurality of
nested tags, the server being further configured to:
generate a simplified inference tagged source string based on the inference tagged source string by removing one or more tags of a first nested order while keeping the one or more tags of a second nested order;
and wherein to generate the inference tagged destination string further comprises the server configured to re-insert the one or more tags of the first nested order.

15. The server of claim 11, wherein the at least one NN is a single NN, to generate the FNP string triplet comprises the server being configured to:
concatenate the source string and the destination string, thereby generating a concatenated source-destination string; and
generate, using the single NN, a FNP concatenated source-destination string, the FNP concatenated source-destination string by inserting the one or more FNPs into the concatenated source-destination string.

16. The server of claim 11, wherein the at least one NN comprises a first NN and a second NN, to generate the FNP string triplet comprises the server being configured to:
provide the source string to the first NN, the first NN being configured to generate the FNP source string by inserting the one or more FNPs into the source string;
provide the FNP source string and the positive destination string to the second NN, the second NN being configured to generate the FNP positive destination string by inserting the one or more FNPs into the positive destination string; and
provide the FNP source string and the negative destination string to the second NN, the second NN being configured to generate the FNP negative destination string by inserting the one or more FNPs into the negative destination string.

17. The server of claim 16, wherein the first NN is configured to operate in a sampling mode and the second NN is configured to operate in a greedy mode.

18. The server of claim 11, wherein the one or more tags are mark-up tags from a mark-up language.

19. The server of claim 18, wherein the mark-up language is HTML.

20. The server of claim 11, wherein to acquire the inference tagged source string comprises the server configured to:
generate an inference source string based on audio data, the inference source string having a first portion indicative of a given speaker and a second portion indicative of uttered content by the given speaker; and
generate a given FNP source string by inserting one or more FNPs of a first type about the first portion of the inference source string, and one or more FNPs of a second type about the second portion of the inference source string.
